(19) United States
(12) Patent Application Publication
(10) Pub. No.: US 2023/0211594 A1
(43) Pub. Date: Jul. 6, 2023

(54) METHOD AND APPARATUS FOR THE PRODUCTION OF A PLANAR CUSHIONING MATERIAL MADE OF PAPER, AND A CUSHIONING MATERIAL

(71) Applicant: Frank DOERMER, Reutlingen (DE)

(72) Inventor: Frank DOERMER, Reutlingen (DE)

(21) Appl. No.: 17/993,031

(22) Filed: Nov. 23, 2022

(30) Foreign Application Priority Data
Jan. 3, 2022 (DE) 10 2022 100 057.5

(51) Int. Cl. B32B 38/06; B32B 3/30; B32B 29/00; B32B 7/12

(52) U.S. Cl. CPC B32B 38/06; B32B 3/30; B32B 29/005; B32B 7/12; B32B 2038/0056

(57) ABSTRACT

An application mechanism is used to apply water to wet paper in a process for producing planar cushioning material and filler material made of paper having a spatial structure with embossing on each side. The water can be applied to the paper like ink, so as to keep it sufficiently moist for the embossing process. Likewise, it is possible to use ink to apply a two-dimensional imprint, whereby sufficient wetting can also take place, but at the same time an optical effect is achieved.

### CROSS REFERENCE TO RELATED APPLICATIONS

Applicant claims priority under 35 U.S.C. § 119 of German Application No. 10 2022 100 057.5 filed Jan. 3, 2022, the disclosure of which is incorporated by reference.

### BACKGROUND OF THE INVENTION

### 1. Field of the Invention

The present invention relates to a method for the production of a planar cushioning material made of paper, wherein the paper is wetted with a fluid, and, preferably in the form of endless paper, passed through between two embossing means of an embossing press, and the embossing means have elevations and cavities that alternate with one another, as embossing elements, which are complementary to one another, in each instance, in such a manner that the embossing means engage into one another as a matrix and a patrix, as well as to an apparatus for this purpose, and a use of an application mechanism for applying or coating a liquid onto a paper to be embossed. Likewise, the invention relates to such a cushioning material.

### 2. Description of the Related Art

Such a method is already previously known from CN 214567598 U. There it is described that a flexible packaging material consists of two paper layers that lie on the outside and one layer that lies on the inside, wherein the layer that lies on the inside has embossings, and thereby the two paper layers that lie on the outside are mounted so as to be spaced apart from one another but nevertheless stable, and a cushioned material is formed in this manner.

Very generally, a comparable cushioning material and a method for the production of such a cushioning material are also described in DE 10 2008 039 550 A1. In this regard, the paper used as the starting material is first crumpled and then brought into the form of a pillow, spiral or ball, and then imprinted as necessary.

With regard to further comparable products, for example with cylindrical embossing, reference is also made to U.S. Pat. No. 3,977,928 A, CN 213924611 U, JP 2008 100758 A, and US 2018/0134476 A1.

Fundamentally, it is known to replace known blister films, which consist of plastic with air inclusions, with material that are more environmentally friendly. Blister films are used as a filler material for packages and as an impact-absorbing packaging material. Impacts that act from the outside are absorbed and cushioned by the air inclusions. However, in order to produce less plastic waste, paper products are being used instead, which can decompose and are produced from natural products. In its normal state, however, paper is not suitable for absorbing impacts. Instead, in the case of an object wrapped in paper, scratches are not expected, but impacts must be expected, so that a further processing step is required to make a suitable cushioning material from paper.

For example, cardboard that consists of multiple layers, at least one of which is corrugated, has already been known for a long time. The at least one corrugated layer is glued in between two outer layers, and ensures spatial widening, wherein the paper is supposed to give way and the interstice is supposed to serve as an impact absorption space.

Something similar can also be done with paper. In this regard, it is known from DE 10 2008 039 550 A1 to crumple the paper and then to shape it. In this regard, as in the case of plastic, an imprint can be applied to the finished product. Pure embossing of paper that as such has only one layer, with alternating in and out curvatures, in other words spatial elements raised out of the paper plane in both directions, is also known, wherein for additional stabilization, a crumpling process can occur first. In this way, the paper becomes multi-layered, at least in certain locations, and thereby more stable. Such sheets of paper, not non-similar to egg boxes, can then easily be used as filler material, and fill up significantly more space than a normal sheet of paper, wherein furthermore, only very little weight is needed so as to perform the filling and supporting function.

A textured embossing with an effective outward dome, which ensures sufficiently extensive cushioning elements, however, is very stressful for the paper. During the embossing process the paper is stretched and thereby thinned out and can tear. This risk of tearing can already be the case for short-fiber paper. In the case of recycled paper having non-determined fiber lengths, the individual fibers do not give way to the tensile stress and the paper has a tendency to tear.

This tendency can be countered in that wetting of the paper with water is undertaken. As a result, the fiber composite softens and allows greater tensile elongation without tearing. The application of the water, possibly in the form of steam, however, represents an additional work step that must be performed in a manual procedure, in a complicated manner, at the present time.

### SUMMARY OF THE INVENTION

Against this background, the present invention is based on the task of creating a method and an apparatus for the production of a planar cushioning material made of paper, which simplifies the wetting of the paper and additionally upgrades the cushioning material.

These and other tasks are achieved by means of a method for the production of a planar cushioning material made of paper, in accordance with the characteristics of one aspect of the invention. Furthermore, these tasks are achieved by means of an apparatus for the production of a planar cushioning material made of paper, in accordance with the characteristics of another aspect of the invention. Finally, these tasks are also achieved by means of an application mechanism for applying a liquid as full-area or surface-patterned wetting of a paper, in accordance with a further aspect of the invention, and the cushioning material that results from this application mechanism, in accordance with an additional aspect of the invention. Practical further developments of the methods and apparatuses, as well as of the product, can be derived from the discussion that follows.

According to the invention, a method for the production of a planar cushioning material made of paper provides that the paper is wetted with a liquid and, preferably in the form of endless paper, passed through between two embossing means of an embossing press, and the embossing means have elevations and cavities, preferably alternating with one another, as embossing elements, which are complementary to one another, in each instance, in such a manner that the embossing means engage into one another as a matrix and a patrix, wherein wetting with the liquid takes place by means of an application mechanism, with which the liquid is applied over the full area or in a surface pattern, in a step that precedes embossing.

By means of the application of a liquid to the paper, the latter softens slightly and thereby allows embossing of relatively high domes without tearing. The use of an application mechanism, in particular of a gluing mechanism or printing mechanism, not only ensures fully automated application in this regard, but also ensures uniform and good metering. Furthermore, the application can take place by means of machines that are generally available, so that a special design can be eliminated. In this regard, a suitable liquid merely has to be kept on hand in the application mechanism and applied to the paper. Such a liquid can be not only water but also ink or a printing ink, as well as glue or an adhesive. This application can take place in a known manner, either by means of application on a continuous surface or by means of application in the form of a surface pattern. In this regard, a surface pattern can be both regular and irregular, a repetition of sections or a one-time section. It can consist of sections with and without liquid or also of sections having one or more layers of liquid.

In this connection, paper should be understood to mean, very generally, a web-form starting material that consists of fiber material. In this regard, the pulp can be brought together to form a fiber composite, and the material can consist of cellulose fibers, in particular of bamboo fibers or grass fibers.

Particularly preferably the wetting can take place with ink in one or more colors and/or with water. In the case of wetting with ink in one or more colors, images and lettering or also patterns such as wallpaper patterns, cross-hatching, geometric patterns and the like can be selected. Water, in contrast, can be applied over the entire surface, above all, or in patterns. For this purpose the water is fundamentally treated like ink, in other words kept on hand in liquid tanks and applied by way of cartridges or nozzles. The paper, for example in the form of endless paper from a roll, is conveyed through the engagement region of the application mechanism, wherein the liquid is applied.

Furthermore, the liquid can be heated using a heating device, preferably a flow-through heater. The heat ensures that the liquid penetrates into the paper better. Aside from heating the liquid, heating of the embossing means can also take alternatively or supplementally; this heating can take place by means of heating elements introduced into them, for example. Also, Joulean heating or inductive heating of the embossing means can be provided, as needed.

Furthermore, the method, as a preferred embodiment, provides that the paper can be a paper having an indefinite fiber length, preferably recycled paper. This paper can also be processed on the basis of the wetting with liquid, and has a positive ecological footprint on the basis of its product from used paper and recycled material. Furthermore, the long fibers of the recycled paper, once they have been separated and newly pressed, solidify to form a stronger composite than is the case for shorter fibers.

Furthermore, preferably the paper can be crumpled or folded in a crumpling mechanism or folding mechanism before or after being printed, but before being embossed in the embossing press. This procedure has the advantage that multiple layers already exist before the application mechanism and the embossing press, so that the resulting cushioning material becomes stronger.

In a concrete embodiment the paper can be rolled further after the crumpling process, then printed and finally embossed. During the crumpling process the paper is compressed in width and forms folds as this compression happens. By means of rolling the paper becomes flat again, and in this state can be printed and wetting in the application mechanism without problems. Also, if an optically appealing pattern is supposed to be printed, this pattern can be sufficiently fixed in place on the paper on the basis of the rolling process, even if the paper was first crumpled and is therefore present in multiple layers at certain locations.

In yet another advantageous embodiment the embossing elements can be alternating spherical calottes and complementary spherical cavities. The concrete shape of spherical calottes allows embossing during which the bulges are given a shape that is as supple as possible and, at the same time, no overly great gradients occur in the topography of the embossing, which would cause overly great stresses during the embossing process. Furthermore, great stability is achieved due to the uniform rises and falls in the contours of the embossing. Alternatively, however, other complementary shapes can also be selected, particularly but not exclusively pyramids, truncated pyramids, cones, truncated cones or cylinders.

It can furthermore be provided, in a particularly advantageous embodiment, that two layers of the cushioning material as described above are glued together to form a layered composite. For this purpose, either an adhesive substance, in particular glue or an adhesive, is applied in the application mechanism, or a second coating takes place in an additional application mechanism, in particular a glue mechanism. Such an additional application mechanism can follow the embossing press and applies the adhesive around the bulges of the cushioning material. In such a case the bulges are, however, only present on one side. In this case a second layer of cushioning material can be applied and glued to the first layer, wherein this layer can preferably be arranged as a mirror image of the first layer. As a result of the mirror-image twisting, the bulges come to be one on top of the other and complement one another to form an air inclusion.

Furthermore an apparatus for the production of a planar cushioning material made of paper is provided, comprising a paper feed that charges an embossing press with the paper, preferably in the form of endless paper, wherein the paper is passed between two embossing means in the embossing press, which means have alternating elevations and cavities as embossing elements and are complementary to one another, wherein the embossing press is preceded by an application mechanism on which the paper can be wetted with a liquid, over its full area or in a surface pattern, wherein the liquid is ink or printing ink in one or more colors and water, or exclusively water, as well as, if applicable, a suitable liquid for loosening and re-linking the fibers.

Such an apparatus allows the production of the cushioning material from the smooth paper raw material. Both wetting with water and imprinting with a full-area print or with a surface pattern are thereby possible.

In concrete terms, heatable liquid tanks can be assigned to the application mechanism, so that a warmed or heated liquid can be directly applied to the paper.

It is particularly advantageous if a line for bringing the liquid from a supply network is assigned to the application mechanism. In principle, this line involves liquid from a water connection that can be directly connected with a liquid tank of the application mechanism. In turn, the application mechanism can draw the water from the tank and apply it to the paper. In order to temper the water in a targeted manner in this regard, the line can have a flow-through heater assigned to it. Using a temperature regulator, a suitable temperature can be set, at which the fibers of the wetted paper are ideally partially dissolved. Furthermore, the ink box or the application rolls, for example, in the application mechanism can be heated in a regulated manner.

Furthermore, heating elements can also be assigned to the embossing means of the embossing press. As a result, embossing of the paper also takes place under the effect of heat, which also quickly dries the fibers of the paper, in addition to the force-fit pressing, due to the heat effect, and bakes them together in the shape predetermined by the embossing press.

Preferably a crumpling mechanism for crumpling the paper can also be arranged between the paper feed and the application mechanism or between the application mechanism and the embossing press. Such a crumpling mechanism ensures that the paper being fed in is present in multiple layers, at least in certain locations, on the basis of the crumpling process, and thereby gains stability.

The embossing means can furthermore, to particular advantage, be embossing rolls between which the paper is passed and embossed, or embossing plates that close around the paper passed between them, and in closing enclose a section of the paper passed between the embossing plates between them.

After all these procedures, the use of an application mechanism for applying a liquid, preferably water, as a full-area or surface-patterned wetting of a paper, preferably an endless paper, before being fed into an embossing press, is particularly preferred.

According to the invention, a planar cushioning material having a paper structure is also provided, comprising a first paper layer that has been embossed on at least one side, which layer has shaped, preferably spherical embossing, wherein the paper structure has at least one second paper layer embossed at least on one side, which is inextricably connected with the first paper layer, with the interposition of an adhesive substance layer.

Therefore, as described above, a single-layer cushioning material is first produced, and this cushioning material is then glued together with several others. This procedure results in a structured flat material that can ultimately be as thick as desired, because of the spatial height that is added, and therefore can be rigid, in spite of the expansive size that increases with every layer. Depending on the thickness of the paper and the distances between the interstices, almost any bodies can be produced in this regard, if applicable also cut out from a block, or such a block can be produced directly by machine from sheets cut to size.

If gluing takes place only along one edge, but preferably along two or ideally along three edges, an insertion sheath or a pocket is formed from the two paper layers, which can serve as a protective sheath for products to be transported in a protected manner.

Furthermore, such a cushioning material can have at least one flat intermediate layer laid in between the at least one first paper layer and the at least one second paper layer. In this way, the construction is given additional rigidity, since bending an arc is prevented by means of the fixation on the intermediate layer.

Furthermore, it is possible to structure the cushioning material in such a manner that the embossings of the least one first and the at least one second paper layer are arranged as a mirror image of one another, and supplement one another to form a cavity, if applicable one through which an intermediate layer passes. The resulting bubbles ensure strength to a particular degree, because the corresponding edges of the embossings lie on top of one another and mutually support each other.

Furthermore, the cushioning material can provide that the first paper layer and the second paper layer have different materials and/or different densities. In this way, for example, a first softer and more gentle contact side, which is supposed to contact a packaged product, and a second more stable and stronger protective side can be created, which is supposed to keep mechanical contacts away from the packaged product.

Supplementally the first paper layer and the second paper layer can be colored in different colors and/or provided with a print in different colors. In this regard, the formulation of a different coloring or a different print should be understood to mean that also one of the paper layers can be colored or imprinted and the other one not. The different coloring means an optical upgrade, on the one hand, but can also mean, in particular, simplification in handling if the properties of the two paper layers are different.

### BRIEF DESCRIPTION OF THE DRAWINGS

Other objects and features of the invention will become apparent from the following detailed description considered in connection with the accompanying drawings. It is to be understood, however, that the drawings are designed as an illustration only and not as a definition of the limits of the invention.

In the drawings,

FIG. 1 shows an apparatus for the production of a cushioning material made of endless paper, having multiple processing stations, in a schematic representation;

FIG. 2 shows an endless paper processed to form a cushioning material, in a schematic top view from above; and

FIG. 3 shows an endless paper passed through an embossing press and processed, in a schematic representation from the side.

### DETAILED DESCRIPTION OF PREFERRED EMBODIMENTS

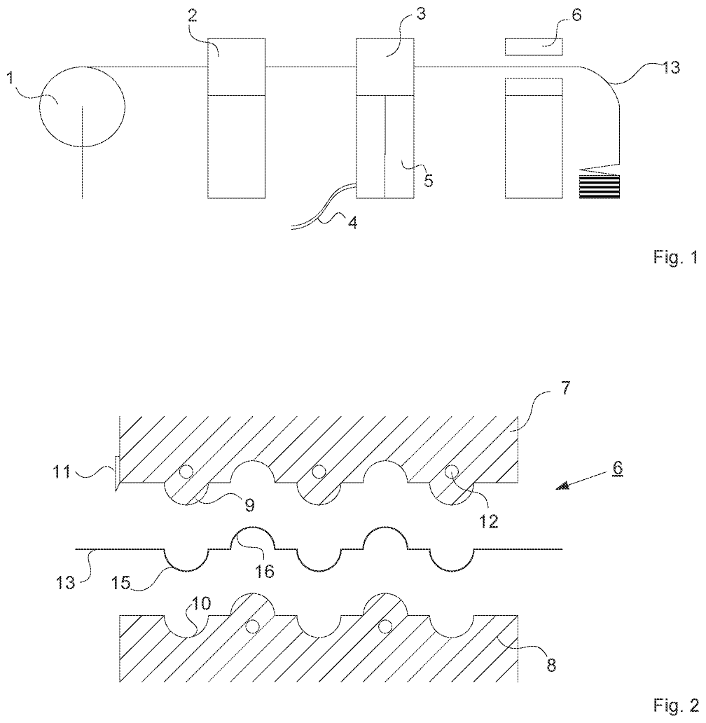

FIG. 1 shows a schematic representation of a production process for the production of a cushioning material from a paper. The paper is at first held on a paper drum 1 as the raw material, and is present as an endless paper 13. This paper is passed from the paper drum 1 first through a crumpling mechanism 2. In the crumpling mechanism 2 the endless paper 13 is at first compressed from the side, so that it develops folds and during this process assumes a narrower format. Using a roll within the crumpling mechanism 2, the endless paper 13 that has developed folds is pressed flat again, wherein it becomes irregularly multi-layered in certain locations and thereby it becomes more stable.

In a next step the endless paper 13 pre-treated in this way is now passed to an application mechanism 3. Here imprinting with one or more different liquids onto the paper can take place. First of all, it is possible to imprint a surface pattern onto the endless paper 13 in a conventional manner, which pattern, however, aside from the optical effect, above all has the background of saturating the paper with liquid, so that this liquid can penetrate into the fibers of the paper. In particular when using recycled paper, this saturation results in advantages, since the paper could tear in the next step, during textured embossing, without wetting. Wetting with water can also take place alternatively or supplementally in the application mechanism 3, however, which water can be applied to the paper in the application mechanism 3, analogous to ink, by way of the outlet nozzles. If necessary, the water can also be supplied to liquid tank 5 by way of a line 4 from a supply line. Furthermore, it is possible, in this connection, to heat the water using a flow-through heater, so that penetration of the paper is improved on the basis of the heat.

The endless paper 13 that has been pretreated with liquid in this manner and has now been moistened is subsequently passed through between two embossing plates of an embossing press 6, which is shown in greater detail in FIG. 2.

The embossing plates are structured as a matrix 7 and a patrix 8, so that they engage into one another in a complementary manner and in doing so clamp the paper, in particular the endless paper 13, between them from both sides. In this regard, the endless paper, the fibers of which have already been softened by the preceding printing, are newly pressed and during this process are heated and baked using the heating means or elements 12 that pass through matrix 7 and patrix 8. The moisture is at least partially driven out during pressing, and the endless paper is embossed to form an extensively rigid spatial structure. Spherical calottes 9 on the surface of the embossing plates (matrix 7, patrix 8) cause alternate convexities 15 and concavities 16 in the surface of the paper, while they are supported with spherical cavities 10 in the other embossing plate (patrix 8, matrix 7), in each instance. The resulting cushioning material becomes many times thicker as a result, and is excellently suited as a filler material due to its flexibility, and for absorbing impacts and shocks to protect an object that it is wrapped around. Using a perforation blade 11, a perforation line 14 can be added to the endless paper. Cutting of individual sheets can also take place here.

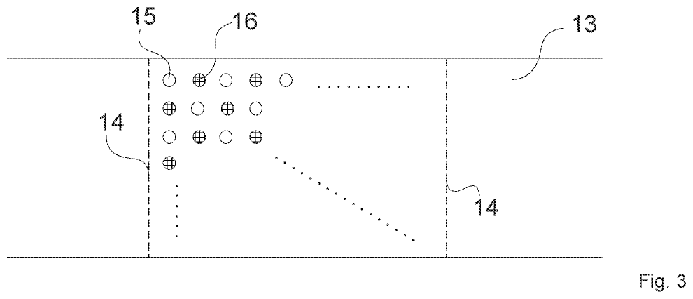

This processing is particularly shown once again in FIG. 3. The endless paper 13 has such perforation lines 14, on both sides, in a section that is pressed between the embossing plates (matrix 7 and patrix 8), and between these lines is alternately provided with convexities 15 and concavities 16. If the liquid used is ink, the endless paper 13 furthermore has a full-area imprint or a surface pattern, which additionally upgrades the endless paper 13.

What have been described above are therefore a method and an apparatus for the production of a planar cushioning material, which simplifies wetting of the paper and additionally upgrades the cushioning material, as well as the use of an application mechanism for the production of such a cushioning material, and the resulting cushioning material in this regard.

Although only a few embodiments of the present invention have been shown and described, it is to be understood that many changes and modifications may be made thereunto without departing from the spirit and scope of the invention.

### REFERENCE SYMBOL LIST

1 paper drum
2 crumpling mechanism
3 application mechanism
4 line
5 liquid tank
6 embossing press
7 matrix
8 patrix
9 spherical calotte
10 spherical cavity
11 perforation blade
12 heating element
13 endless paper
14 perforation line
15 convexity
16 concavity

What is claimed is:

1. A method for the production of a planar cushioning material made of paper, wherein the paper is wetted with a liquid, and, preferably in the form of endless paper (13), passed through between two embossing means of an embossing press (6), and the embossing means have elevations and cavities that alternate with one another, as embossing elements, which are complementary to one another, in each instance, in such a manner that the embossing means engage into one another as a matrix (7) and a patrix (8),
wherein the wetting with the liquid takes place by means of an application mechanism (3), with which the liquid is applied or coated over the full area or in a surface pattern, in a step that precedes embossing.

2. The method according to claim 1, wherein the wetting takes place with ink in one or more colors and/or with water.

3. The method according to claim 1, wherein the liquid is heated using a heating device, preferably a flow-through heater.

4. The method according to claim 1, wherein the embossing means are heated.

5. The method according to claim 1, wherein the paper is a long-fiber paper, preferably recycled paper.

6. The method according to claim 1, wherein the paper is crumpled in a crumpling mechanism (2) or folded in a folding mechanism before or after being printed, but before being embossed in the embossing press (6).

7. The method according to claim 6, wherein the paper is rolled after the crumpling process or folding process, afterward imprinted, and finally embossed.

8. The method according to claim 1, wherein the embossing elements are alternating spherical calottes (9) and complementary spherical cavities (10), or complementary embossing elements in the form of pyramids, truncated pyramids, cones, truncated cones or cylinders.

9. The method according to claim 1, wherein an adhesive substance is applied to the paper with the application mechanism (3) or a further application mechanism that follows the embossing press, in particular a gluing mechanism, wherein in a subsequent connection step, two layers embossed on one side, made of the planar cushioning material, are connected with one another, preferably with mirror symmetry, causing inclusion of a space between two corresponding convexities (15).

10. The method according to claim 9, wherein the gluing takes place over the full area or along one or more edges, preferably along three edges, forming a pocket.

11. The method according to claim 9, wherein connecting the two layers of planar cushioning material takes place with the interposition of at least one further paper layer.

12. An apparatus for the production of a planar cushioning material made of paper, comprising a paper feed that charges an embossing press (6) with the paper, preferably in the form of endless paper (13), wherein the paper is passed between two embossing means in the embossing press (6), which means have alternating elevations and cavities as embossing elements and are complementary to one another,
wherein
the embossing press (6) is preceded by an application mechanism (3) on which the paper can be wetted with a liquid, over its full area or in a surface pattern, wherein the liquid is ink or printing ink in one or more colors and water, or exclusively water.

13. The apparatus according to claim 12, wherein heatable liquid tanks (5) are assigned to the application mechanism (3).

14. The apparatus according to claim 12, wherein a line (4) for bringing the liquid from a supply network is assigned to the application mechanism (3).

15. The apparatus according to claim 14, wherein a flow-through heater is assigned to the line (4).

16. The apparatus according to claim 12, wherein heating elements (12) are assigned to the embossing means.

17. The apparatus according to claim 12, wherein a crumpling mechanism (2) for crumpling and/or a folding mechanism for folding the paper is arranged between the paper feed and the application mechanism (3) or between the application mechanism (3) and the embossing press (6).

18. The apparatus according to claim 12, wherein the embossing means are embossing plates or embossing rolls.

19. A planar cushioning material having a paper structure, comprising a first paper layer embossed on at least one side, which has shaped, preferably spherical embossings,
wherein the paper structure has at least one second paper layer embossed on at least one side, which is inextricably connected with the first paper layer, with the interposition of at least one adhesive substance layer.

20. The cushioning material according to claim 19, wherein the first paper layer and the second paper layer are glued to one another over their full area or along one or several edges, preferably along three edges, forming a pocket.

21. The cushioning material according to claim 19, wherein a flat intermediate layer is interposed between the at least one first paper layer and the at least one second layer.

22. The cushioning material according to claim 19, wherein the embossings of the at least one first and the at least one second paper layer are arranged as a mirror image of one another, and supplement one another to form a cavity, if applicable one through which an intermediate layer passes.

23. The cushioning material according to claim 19, wherein the first paper layer and the second paper layer have different materials and/or different densities.

24. The cushioning material according to claim 19, wherein the first paper layer and the second paper layer are colored in different colors and/or provided with an imprint in different colors.
